(19) United States
(12) Patent Application Publication
(10) Pub. No.: US 2007/0207358 A1
(43) Pub. Date: Sep. 6, 2007

(54) Fuel Cell Stack and Related Method

(75) Inventor: Motoharu Obika, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/578,993

(22) PCT Filed: Apr. 14, 2005
(86) PCT No.: PCT/JP05/07569

§ 371 Date: Oct. 19, 2006

(30) Foreign Application Priority Data
Apr. 20, 2004 (JP) 2004-124061

(51) Int. Cl. H01M 8/02; H01M 8/10; H01M 8/24

(52) U.S. Cl. 429/32; 429/37; 429/38

(57) ABSTRACT

A fuel cell stack (FS) is provided with a plurality of unit cells (1) stacked in a stack direction to form a stack body (3), a pair of fixing members (37, 39) disposed on both sides of the stack body in the stack direction (y), a plurality of rod members (6, 6′, 63, 65, 67, 69), and a plurality of tightening members (41) screwed onto the plurality of rod members to form a plurality of tightening portions, and tightening and rotating directions of the plurality of tightening portions are set such that the tightening and rotating directions of the tightening portions are opposite to that of at least one tightening portion (63, 41).

### TECHNICAL FIELD

The present invention relates to a fuel cell stack and a related method and, more particularly, to a fuel cell stack and its related method wherein an anode electrode, a cathode electrode and an electrolyte membrane, which is sandwiched between the anode electrode and the cathode electrode, are sandwiched between a pair of separators to form a unit cell upon which a plurality of unit cells are stacked to form the fuel cell stack.

### BACKGROUND ART

In a polymer electrolyte fuel cell (PEFC), a given number of unit cells are stacked to form a fuel cell stack. The fuel cell stack includes a unit cell wherein a membrane electrode assembly (MEA), comprised of an electrolyte membrane (polymer ion exchange membrane: positive ion, i.e., proton exchange membrane), is sandwiched between an anode electrode and a cathode electrode, and the membrane is sandwiched on both sides between a pair of separators. The anode electrode and cathode electrode include catalyst layers and gas diffusion layers, respectively. Further, in general, with PEFC, a given number of unit cells are stacked, thereby forming a fuel cell stack.

With such a fuel cell stack, fuel gas (hydrogen containing gas, for example, hydrogen) supplied to the anode electrode is ionized on the catalyst layer to form hydrogen ions, which are appropriately humidified and transfer to the cathode electrode via the electrolyte membrane while electrons are extracted in an external circuit for use as electric energy in direct current. In this moment, since the cathode electrode is supplied with oxidized gas (oxygen containing gas, for example, air), reactions occur on the cathode electrode between the hydrogen ions, electrons and oxygen to produce water.

Japanese Patent Application Laid-Open Publication No. 2002-56882 discloses a structure wherein in order to construct a fuel cell stack, fixing members, such as so-called end plates, are placed on both ends and a plurality of tension rods are penetrated between the end plates to be tightened.

### DISCLOSURE OF INVENTION

However, upon studies conducted by the present inventor, such a structure undergoes tightening torques, caused by tightening nuts screwed onto threaded portions on distal ends of the tension rods, by which stack component elements are caused to rotate thereby generating distortion of the stack as a whole. Under such a status wherein distortion occurs, it is conceived that the presence of thermal expansions of the stack component parts, resulting from temperature rise during operation of the fuel cell stack, results in a tendency causing uneven surface pressure distributions among the component parts of the fuel cell stack with the resultant adverse affects on exertion of performance and durability.

The present invention has been completed with such studies conducted by the present inventor and has an object to provide a fuel cell stack and its related method aimed to prevent an entire stack from being distorted when tightening a fuel cell stack using tightening members.

To achieve the above object, an aspect according to the invention provides a fuel cell stack comprising: a plurality of fuel cells stacked in a stack direction to form a stack body, each of the plurality of fuel cells including an electrolyte membrane, an anode electrode placed on one side of the electrolyte membrane, a cathode electrode placed on the other side of the electrolyte membrane, and a pair of separators between which the anode electrode, the electrolyte membrane and the cathode electrode are sandwiched; a pair of fixing members disposed on both sides of the stack body in the stack direction, the stack body and the pair of fixing members forming a stack structural part; a plurality of rod members penetrating through the stack body and the pair of fixing members; and a plurality of tightening members available to screw onto the plurality of rod members to form a plurality of tightening portions, respectively, whose tightening and rotating directions are set such that the tightening and rotating direction of the other tightening portion is set to be opposite to that of at least one tightening portion.

In the meanwhile, another aspect of the invention provides a method of tightening a fuel cell stack which has a plurality of unit cells stacked in a stack direction to form a stack body, a pair of fixing members disposed on both sides of the stack body in the stack direction thereof, a plurality of rod members penetrating through the stack body and the pair of fixing members, and a plurality of tightening members screwed onto the plurality of rod members to form a plurality of tightening portions, respectively, the method comprising: penetrating a plurality of rod members through the stack member and the pair of fixing members; and permitting the plurality of rod members and a plurality of tightening members to screw on each other such that a tightening and rotating direction of the other one of the plurality of tightening portions is set to be opposite to that of at least one of the plurality of tightening portions.

Other and further features, advantages, and benefits of the present invention will become more apparent from the following description taken in conjunction with the following drawings.

### BRIEF DESCRIPTION OF DRAWINGS

FIG. 1 is a perspective view showing fundamental structural elements of a fuel cell stack of a first embodiment according to the present invention;

FIG. 2 is an exploded perspective view showing a structure of a unit cell of the fuel cell stack of the presently filed embodiment;

FIG. 3 is a cross-sectional view taken on line A-A of FIG. 1 showing a structure, in which a pressing mechanism is further incorporated, of the fuel cell stack of the presently filed embodiment;

FIG. 4 is a schematic view showing a structure of an end plate, as viewed in a direction B in FIG. 1, of the fuel cell stack of the presently filed embodiment;

FIG. 5 is a schematic view, corresponding to FIG. 4, showing a structure of comparison example wherein tightening and rotating directions of all tension rods are set to the same direction, on which various studies have been conducted in the presently filed embodiment;

FIG. 6 is a schematic view, corresponding to FIG. 4, showing a structure of an end plate of a fuel cell stack of a second embodiment according to the present invention;

FIG. 7 is a schematic view, corresponding to FIG. 4, showing a structure of an end plate of a fuel cell stack of a third embodiment according to the present invention; and

FIG. 8 is a schematic view, corresponding to FIG. 4, showing a structure of an end plate of a fuel cell stack of a fourth embodiment according to the present invention.

### BEST MODE FOR CARRYING OUT THE INVENTION

Hereinafter, fuel cell stacks and related methods of various embodiments according to the present invention are described with reference to the accompanying drawings. Incidentally, although the fuel cells of the various embodiments will be described taking PEFCs as examples, no limitation is intended to such applications. Besides, throughout the drawings, x-, y- and z-axes form a three-axis rectangular coordinate system.

### First Embodiment

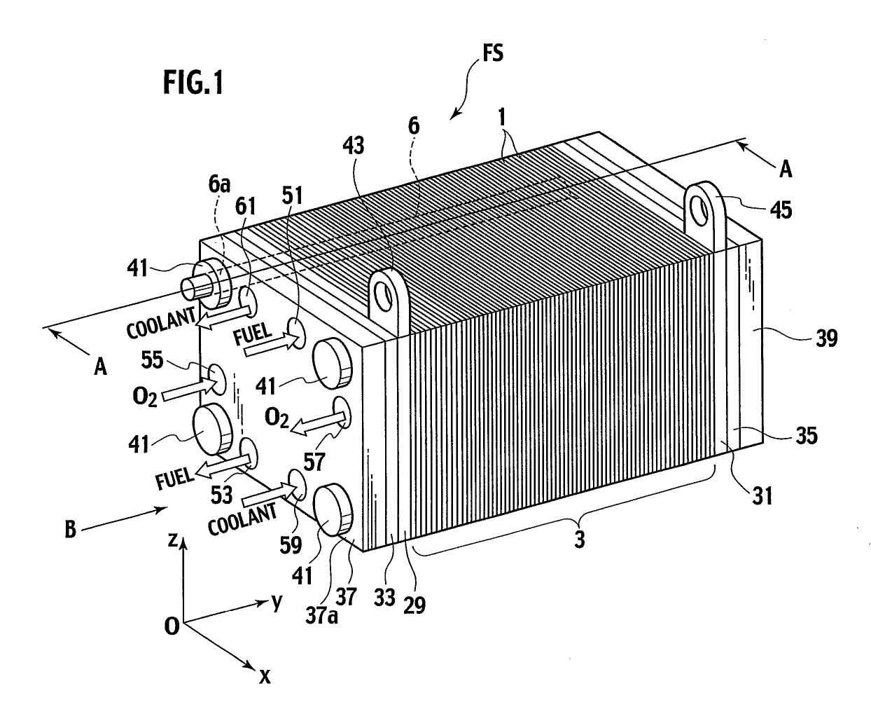

First, a fuel cell stack and its related method of a first embodiment according to the present invention are described in detail with reference to FIGS. 1 to 5.

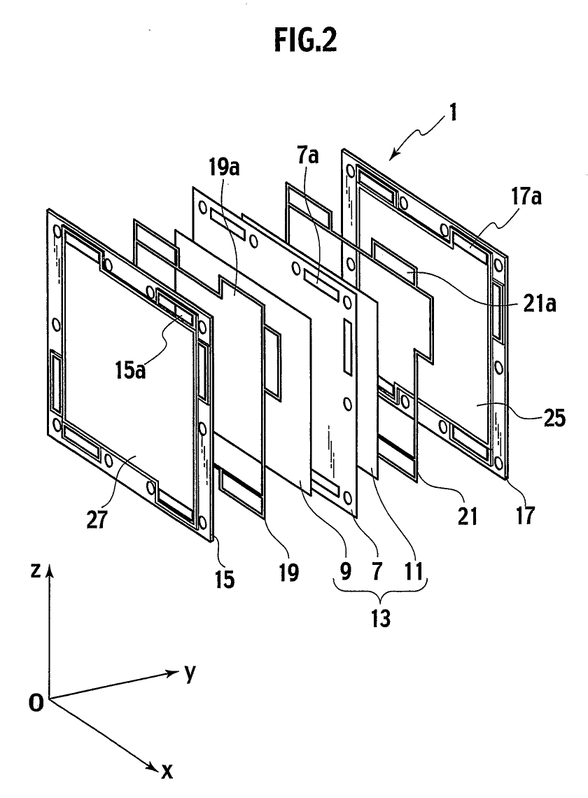

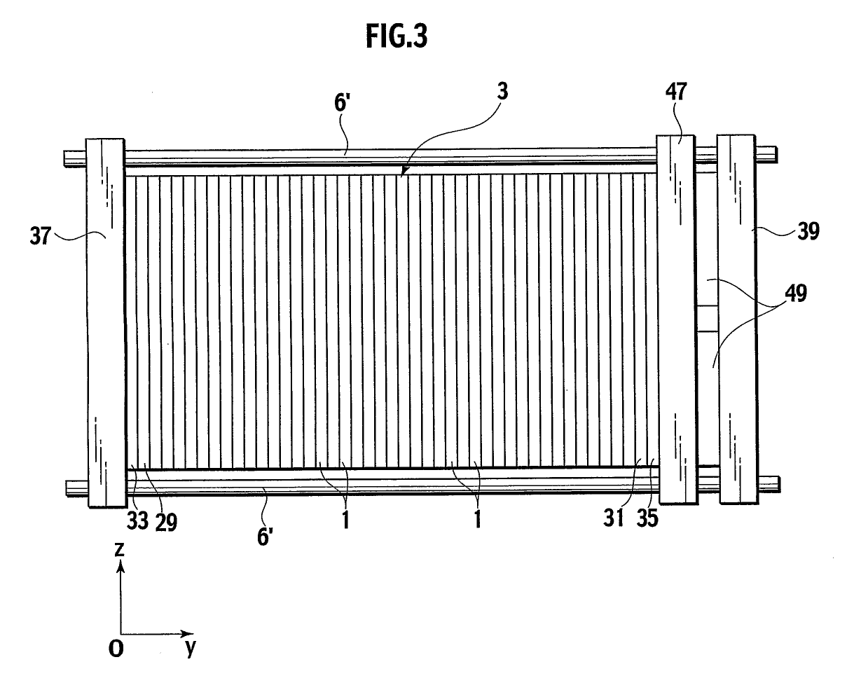

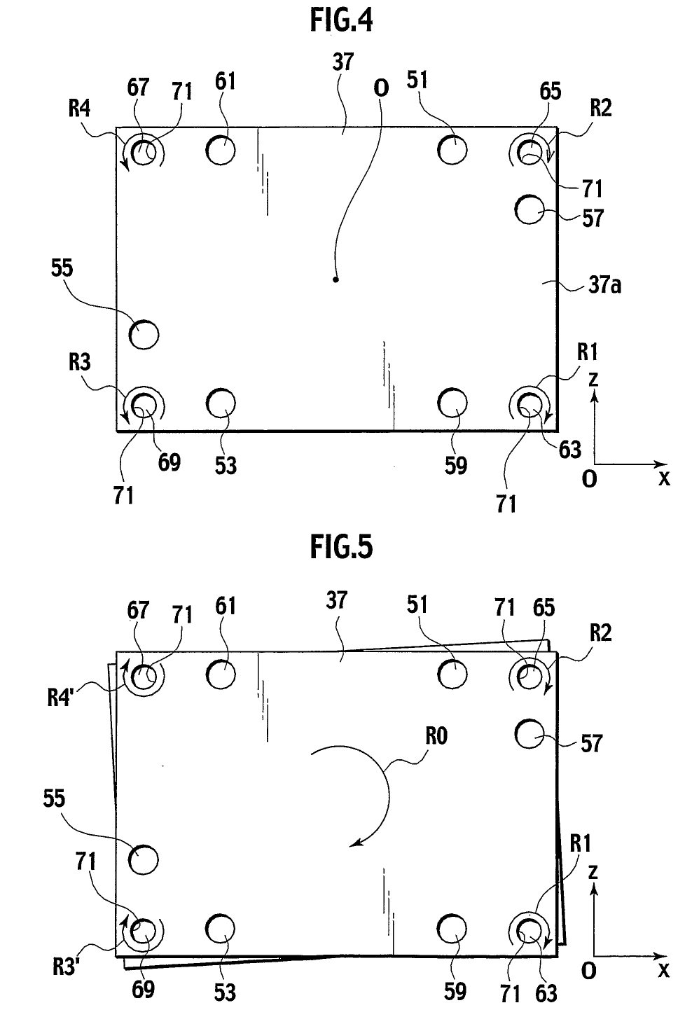

FIG. 1 is a perspective view of a fundamental structural elements of the fuel cell stack of the presently filed embodiment; FIG. 2 is an exploded perspective view showing a structure of a unit cell in the fuel cell stack of the presently filed embodiment; FIG. 3 is a cross-sectional view taken on line A-A of FIG. 1 showing a structure in which a pressing mechanism is additionally incorporated in the fuel cell stack of the presently filed embodiment; FIG. 4 is a schematic view showing a structure of an end plate, as viewed in a direction B (in a direction parallel to y-axis) in FIG. 1, of the fuel cell stack of the presently filed embodiment; and FIG. 5 is a schematic view, corresponding to FIG. 4, showing a structure of a comparison example wherein tightening and rotating directions of all tension rods are set to the same direction, on which various studies have been conducted in the presently filed embodiment.

As shown in FIG. 1, the fuel cell stack FS is comprised of a stack body 3 composed of a plurality of unit cells 1, each of which generates electric power with a voltage (open circuit voltage) of 1V. The plural unit cells 1, forming the stack body 3, serves as fuel cells, respectively. Although a detailed structure of the fuel cell stack is described below, the fuel cell stack FS is fixed by tension rods 6 that are placed in four corners through which the rods 6 internally penetrate. Incidentally, although only one rod has been shown in the drawing figure, the rods are placed in the four corners and the total number of rods is 4. In principle, it is of course to be noted that the number of rods is not limited to 4 and any number of rods may be used provided that a desired fixing force can be obtained.

As shown in FIG. 2 in detail in an exploded form, the unit cell 1 includes an MEA 13 that is comprised of an electrolyte membrane 7 composed of a polymer ion exchange membrane, an anode electrode (fuel electrode) 9 disposed on one side of the electrolyte membrane 7 and including a gas diffusion layer, a water repellent layer and a catalyst layer, and a cathode electrode (air electrode) 11 disposed on the other side of the electrolyte membrane 7 and composed of a gas diffusion layer, a water repellent layer and a catalyst layer.

In addition, separators 15, 17 are placed on both sides of the MEA 13 via gaskets 19, 21, respectively, and formed with fluid flow channels through which fuel gas (hydrogen) is supplied to the anode electrode 9 and fluid flow channels through which oxidized gas (oxygen, air in normal practice) is supplied to the cathode electrode 11, respectively.

The electrolyte membrane 7 includes a proton conductive ion exchange membrane formed of polymer material such as fluorocarbon resin and exhibits favorable electrical conductivity under wet conditions.

Both the anode electrode 9 and cathode electrode 11 include gas diffusion electrodes, respectively. Each gas diffusion electrode includes the gas diffusion layer, the water repellent layer and the catalyst layer. The gas diffusion layer is formed of material with adequate gas diffusion property and electrical conductivity such as, for instance, a carbon cloth woven with yarns made of carbon fiber, a carbon paper or a carbon felt. The water repellent layer includes a layer containing polyethylene-fuluoroethylene and carbon material that provides a water repellent property. The catalyst layer is formed of carbon black carrying thereon, for instance, platinum and has a function as a catalyst.

Incidentally, the catalyst layer is not limited to a structure formed with the electrode carried on the gas diffusion layer and may include a structure composed of the electrolyte membrane 7 whose surface carries thereon catalyst such as platinum and alloy made of platinum and other metal. In such a case, the anode electrode 9 and cathode electrode 11 form a gas diffusion layer composite body composed of only the water repellent layer laminated on a surface of the gas diffusion layer.

The separators 15, 17 are formed of material exhibiting enough conductivity, strength, and corrosion resistance. For example, the separators 15, 17 may be made by press forming with carbon material and of course, if enough corrosion resistance or the like is realized, another material such as metal may be used.

A surface, closer to the anode electrode 9, of the separator 15 is formed with fuel gas flow channels (not shown) and, likewise, a surface, closer to the cathode electrode 11, of the separator 17 is formed with oxidized gas flow channels 25 (not shown). Also, the other surface of the separator 15, in opposition to the anode electrode 9, is formed with coolant medium flow channel 27 and the other surface of the separator 17 in opposition to the cathode electrode 11 is formed with coolant medium flow channel (now shown).

The gaskets 19, 21 are formed of rubber-like resilient materials such as silicone rubber, Ethylene Propylene Dien Terpolymer rubber (EPDM) or fluorocarbon rubber. Of course, it doesn't matter if the gaskets 19, 21 are unitized with the separators 15, 17 or thin sheet materials with increased elastic coefficients, respectively. The thin sheet materials with increased elastic coefficients formed of materials such as polycarbonate and polyethylene telephthalate may be bonded to the electrolyte membrane 7 by means of liquid-like seal such as, for instance, thermoset fluorine or thermoset silicone.

Using component parts as set forth above allows the fuel cell stack FS, composed of a plurality of unit cells 1, to be formed in a structure, as shown in FIG. 1, which has both ends on which current collector plates 29, 31, insulation plates 33, 35 and end plates 37, 39 serving as fixing members are disposed in a stack direction (in a direction parallel to the y-axis) of the stack body 3. Here, it is considered that the current collector plates 29, 31, the insulation plates 33, 35 and the end plates 37, 39 are involved as stack component parts. The tension rods 6 are inserted to the fuel cell stack FS at four corners thereof and have threaded portions 6a, formed on distal ends of the tension rods 6, to which nuts 41 are screwed and tightened to tighten the stack component parts. Incidentally, each of the tension rods 6 is made of metallic material with rigidity, such as for instance steel and, with a view to precluding the occurrence of electrical shortage between the adjacent unit cells 1, a surface of each rod 6 is subjected to insulation treatment. Also, the nuts 41 may be sufficed to be of the types that are tightened to the associated rods 6 in abutting engagement with and forcibly pressed against the end plate 37 to mount the end plates 37, 39 on the stack body 3 in a reliable manner. To this end, the nuts 41 may include not only hexagon nuts, respectively, but also other shapes regardless of the presence of nuts with flanges or box nuts and may employ washers if desired.

The current collector plates 29, 31 are formed of gas impermeable conductive members such as dense carbon plates or copper plates, and the insulation plates 33, are formed of insulation members such as rubber or resin.

The end plates 37, 39 are formed of rigid material, that is, metallic material such as steel. Moreover, formed on the current collector plates 29, 31, respectively, are output terminals 43, 45, through which electric power generated in the fuel cell stack is outputted.

A method of tightening the fuel cell stack through the use of the rods 6 has no need for all the tension rods 6 to penetrate through an interior of the stack body 3, and the fuel cell structure may be configured such that the end plates 37, 39 are tightened at the outside of the stack body 3.

As shown in FIG. 3, further, an alternative may take a structure such that an inside end plate 47 is disposed between the end plate 39 of the stack body on one end thereof in the stack direction and the insulation plate 35 located inside of the end plate 39 in the stack direction and a pressing mechanism 49, composed of a spring or the like, is disposed between the end pate 39 and the inside end plate 47 whereby the end plates 37, 39 are tightened by the tension rods 6′. Incidentally, here, the tension rods 6′ are disposed outside the stack body 3′.

Further, a fuel gas inlet 51 and a fuel gas outlet 53, an oxidized gas inlet 55 and an oxidized gas outlet 57, and a coolant water inlet 59 and a coolant water outlet 61 are formed in the end plate 37 located on the other end of the fuel cell stack, respectively. Delivery flow channels, connected in communication with these inlets, for fuel gas, oxidized gas and coolant water, collective flow channels, connected in communication with these outlets, for fuel gas, oxidized gas and coolant water, are formed in and extend through the current collector plate 29, the insulation plate 33 and the stack body 3, respectively. The flow delivery channels and collective flow channels communicate with associated flow channels of the fuel gas flow channel formed in the separator 15 on the side closer to the anode electrode 9, the oxidized gas flow channel 25 formed in the separator 17 on the side closer to the cathode electrode 11, and the coolant medium flow channel 27.

With a view to forming the delivery flow channels in the stack body 3, as shown in FIG. 2, the separator 15, the gasket 19, the electrolyte membrane 7, the gasket 21 and the separator 17 are formed with fuel gas inlet continuous holes 15a, 19a, 21a, 17a in positions corresponding to the fuel gas inlet 51, respectively. Likewise, the fuel gas outlet 53, the oxidized gas inlet 55 and the oxidized gas outlet 57, and the coolant water inlet 59 and the coolant water outlet 61 have associated continuous holes, respectively.

Hereunder, a structure and method of tightening the fuel cell stack using the tension rods of the presently filed embodiment are described below further in detail with reference particularly to FIG. 4 taking the one end plate 37 as an example. Incidentally, the four tension rods bear reference numerals 63, 65, 67, 69, respectively, for the sake of convenience. Furthermore, the end plate 37 has holes, through which the tension rods 63, 65, 67, 69 are inserted in closed contact with entire peripheries, which bear the same reference numerals 71 for the sake of convenience. Moreover, the other end plate 39 takes a structure wherein the tension rods 63, 65, 67, 69 may include stud members fixed to the end plate 39 by welding or may be tightened to nuts welded to the end plate 39 or may suitably take the same structure as the tightening structure of the end plate 37.

As shown in FIG. 4, more particularly, the tension rods 63, 65, 67, 69, disposed on the four corners of the fuel cell stack, are fixedly tightened in tightening and rotating directions (as used herein, the term “tightening and rotating direction” refers to a rotational direction of the nut 41 screwed onto the threaded portion of the distal end of the tension rod as viewed downward from the above on a paper sheet of FIG. 4 in a direction perpendicular thereto) such that the tension rods 63, 65, disposed on lower and upper areas on the right side in FIG. 4, are set to a clockwise direction (as shown by arrows R1, R2 and the tension rods 67, 69, disposed on upper and lower areas on the left side in FIG. 4, are set to a counterclockwise direction (as shown by arrows R3, R4).

That is, with a view to causing no rotational motion to occur on the stack component parts, serving as a member to be tightened during tightening work, that is, causing no rotational motion to occur on the end plate 37 in direct, the plural tightening portions of rotating and tightening types, including the tension rods 63, 65, 67, 69 and the nuts 41, respectively, are set such that the tightening and rotating direction (the right-hand screw) of the tension rod 63 and the tightening and rotating direction (the left-hand screw) of the tension rod 67, placed in a position symmetric with respect to a center point O of a plate surface 37a of the end plate 37, are set to be opposite and, further, the tightening and rotating direction (of the right-hand screw) of the tension rod 63 and the tightening and rotating direction (of the left-hand screw) of the tension rod 69, placed in the other end on the same side of the plate surface 37a, are set to be opposite. Incidentally, the tightening and rotating direction of the tension rod 65 is set in the same direction (the right-hand screw) as that of the tension rod 63.

Further, from the stand point of causing no unnecessary rotational motion to occur on the stack component parts such as the end plate 37 during tightening work, the plural tightening portions, composed of the tension rods 63, 65, 67, 69 and the nuts 41, are elaboratedly located in positions symmetric with respect to the center point O of the plate surface 37a (on a plane parallel to the x-z plane) in a reliable manner.

To say more in principle, by setting the tightening and rotating direction of at least one tightening portion of the plural tightening portions, each with a structure composed of the tension rod and nut, to be opposite to those of the other tightening portions, the member such as the end plate to be tightened is possibly prevented from suffering from extra rotational motion. To say more ideally, by locating the plural tightening portions in the symmetrical positions and setting the tightening and rotating directions of these component elements to be suitably opposite in order to enable momentums, occurring in the member to be tightened, accompanied by rotational motions of the tightening portions, to be counterbalanced like the presently filed embodiment, it becomes possible to realize a structure with no rotational motions occurring on the member to be tightened.

Further, the tightening portions may be tightened such that all the tightening portions are temporarily tightened first and, then, fully tightened on a final stage along the manner as mentioned in the presently filed embodiment. If the temporarily tightening is employed, the temporarily tightening may be made in the same sequence as that of the fully tightening process, that is, in the same tightening and rotation directions and the same order in tightening as those of the fully tightening process.

Furthermore, an assembling procedure may be implemented such that the tension rod 63 is initially tightened and, subsequently, for instance, the tension rod 67 on the left and upper side, the tension rod 69 on the left and lower side and the tension rod 65 on the right and upper side are tightened in this order.

Moreover, with such a structure, during the tightening of the tension rod 63, the positioning of the tension rod 63 is made with respect to a translational movement of the stack component parts and also the positioning of the other three tension rods 65, 67, 69 than the tension rod 63 is carried out with respect to the rotational motion of the stack component parts centering on the tension rod 63.

On the contrary, as shown in a comparison example shown in FIG. 5, if a structure includes a configuration wherein all the tension rods 63, 65, 67, 69 are tightened in the same tightening and rotating directions, that is, the rotational directions of the tension rods 63, 65 remain clockwise whereas the tightening and rotating directions of the tension rods 67, 69 are altered to the clockwise direction as indicated by arrows R13, R14, the end plate 37 is caused to rotate clockwise as shown by an arrow RO with the resultant displacement from the other remaining stack components, resulting in misalignment among the stack component parts with respect to one another to cause a morphologic distortion in an overall structure of the fuel cell stack as viewed in the y-direction.

As set forth above, with the structure of the presently filed embodiment, it becomes possible to eliminate momentums for the fuel cell stack to be distorted during tightening work, making it possible to preclude the occurrence of the distortion in the overall structure of the fuel cell stack.

Further, by setting the tightening portions of respective tension rods 63, 67, located in diagonal positions, to be opposite in rotational direction while, similarly, setting the tightening portions of respective tension rods 65, 69, located in diagonal positions, to be opposite in rotational direction, the occurrence of distortion of the fuel cell stack can be more reliably prevented.

With the distortion precluded in such a way, a surface pressure distribution appearing on the fuel cell stack can be equalized even in the presence of thermal expansions on the stack component parts due to temperature rise in the fuel cell stack during operation thereof. Also, precluding the occurrence of distortion enables the fuel cell stack to be accommodated in a casing (not shown) without interference with an internal wall thereof.

Incidentally, there is no need for the tension rods to include four pieces and the number of tension rods may be suitably set on consideration of a subject property and tightening capabilities. Also, cross-sectional areas of the tension rods may suitably employ not only a circular shape but also other configurations such as elliptical or rectangular shape and, in comply with the cross-sectional shape of the tension rods, the through-holes may take not only a circular shape but also other shapes such as elliptical and rectangular shapes.

### Second Embodiment

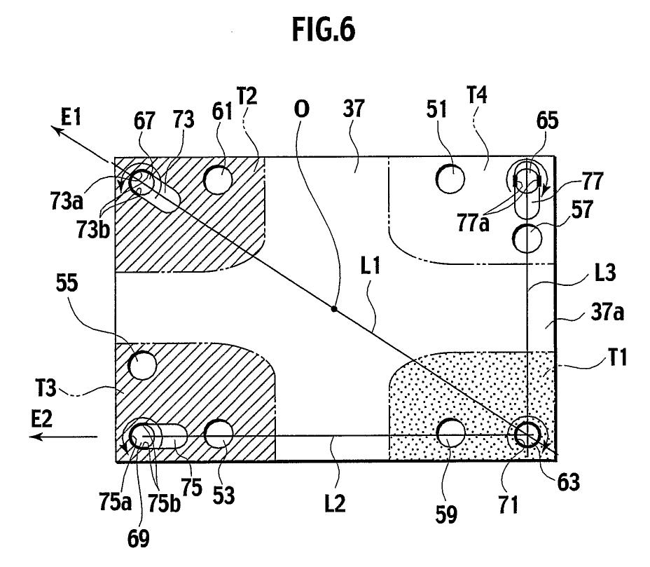

Next, a fuel cell stack and its related method of a second embodiment according to the present invention are described below in detail mainly with reference to FIG. 6.

FIG. 6 is a schematic view, corresponding to FIG. 4, which shows a structure of an end plate of the fuel cell stack of the presently filed embodiment.

The presently filed embodiment differs from the first embodiment in that the fuel cell stack of the presently filed embodiment has a structure on which a further detailed study is conducted for a temperature distribution pattern of a component element resulting from heat built up in the fuel cell stack. Hereunder, with attention focused on such a difference, the same component parts bear like reference numerals to suitably simplify or omit description.

More particularly, in the fuel cell stack FS, the temperature rises to a value of approximately 80° C. to 90° C. during operations to generate electric power in a temperature distribution pattern wherein a temperature distribution on a plane (parallel to the x-z plane) perpendicular (in a direction parallel to the y-axis) to the stack direction of the stack body 3, for instance, a plate surface 37a of the end plate 37, has a tendency where the temperature in an area T1 in the vicinity of the coolant water inlet 59 is low and the temperature in an area T2 in the vicinity to the coolant water outlet 61 is higher than that in the area T1. Also, there is a tendency wherein the temperature in an area T3 in the vicinity of the fuel gas outlet 53 is higher than that of the area T1. Besides, in the drawing figure, the areas T1 to T3 are schematically shown on a conceptual basis.

Therefore, in consideration of the tendencies of such temperature distributions, a structure is adopted wherein a first tightening portion to exhibit a tendency in less thermal expansion is set to the tension rod 63, to be located in the area T1 close proximity to the coolant water inlet 59 low in temperature during operation to generate electric power, so as to allow the tension rod 63 to have a positioning function, while tolerances are given to the other tightening portions (involving second to fourth tightening portions).

That is, for the purpose of forming a first tightening portion in the area T1 close proximity to the coolant water inlet 59 with the tendency in less thermal expansion, the tension rod 63, to which the nut 41 is tightened, is inserted to a first through-hole 71, serving as a positioning hole, which extends through the stack body 3. The positioning hole 71 takes a circular shape corresponding to a circular cross-sectional shape of the tension rod 63 and the tension rod 63 is inserted to the positioning hole 71 in closed contact with an entire inner peripheral wall thereof while achieving the positioning.

In the meanwhile, for the purpose of forming a second tightening portion in the area T2 close proximity to the coolant water outlet 61 with the tendency in an increased thermal expansion, the tension rod 67 is inserted to an elongated slot 73 serving as a second through-hole that extends through the stack body 3. Likewise, the tension rod 69, to which the nut 41 is tightened for the purpose of forming a third tightening portion in the area T3 close proximity to the fuel gas outlet 53 is inserted to an elongated slot 75 serving as a third through-hole that extends through the stack body 3. In addition, the tension rod 65, to which the nut 41 is tightened for the purpose of forming a fourth tightening portion in the area T4 close proximity to the oxidized gas outlet 57 is inserted to an elongated slot 77 serving as a fourth through-hole that extends through the stack body 3.

Here, since the second tightening portion, in which the tension rod 67 is located, is subjected to thermal expansion in a direction as shown by an arrow E1 with respect to the first tightening portion on which the tension rod 63 is located, the elongated slot 73 is formed in an elongated configuration such that a long axis lies on a straight line segment (on a diagonal line L1 on the plate surface 37a) interconnecting the tension rods 63, 67 to one another and linear portions 73b, parallel to one another, extend in parallel to that straight line segment.

Further, since the third tightening portion, in which the tension rod 69 is located, is subjected to thermal expansion in a direction as shown by an arrow E2 with respect to the first tightening portion on which the tension rod 63 is located, the elongated slot 75 is formed in an elongated configuration such that a long axis lies on a straight line segment L2 interconnecting the tension rods 63, 69 to one another and linear portions 75b, parallel to one another, extend in parallel to that straight line segment.

In addition, upon seasoning the shapes of the elongated slots 73, 75 in consideration of thermal expansions, an elongated slot 77 is formed in an elongated configuration such that a long axis lies on a straight line segment L3 interconnecting the tension rods 63, 65 to one another and linear portions 77a, parallel to one another, extend in parallel to that straight line segment.

Now, the tension rod 67 is held in close contact with a circular arc distal end inner wall 73a of the elongated slot 73, to which the tension rod 67 is inserted, and also partially held in contact with the linear portions 73b of the elongated slot 73. Simultaneously, the tension rod 69 is held in close contact with, for instance, a circular arc distal end inner wall 75a of the elongated slot 75 and also partially held in contact with the linear portions 75b of the elongated slot 75. Likewise, the tension rod 65 is inserted such that the tension rod 65 is positioned to be separate from a circular arc distal end inner wall of the elongated slot 77 and partially held in contact with the linear portions 77a of the elongated slot 77.

Furthermore, as for an assembling order, the tension rod 63 is initially tightened and, subsequently, the tension rod 67, located in the left and upper side to be symmetric about the center point O of the end plate 37 and subjected to thermal expansion, is tightened. Thereafter, the tension rod 69, located in the left and lower side that is subjected to thermal expansion, is tightened and the remaining tension rod 65, in the right and upper side is lastly tightened. Here, with preliminary experimental tests repeatedly conducted, tightening torques of the tension rods 67, 69 are set to values available for these tension rods to be relatively movable along the elongated slots 73, 75 during thermal expansions of the stack component parts.

Moreover, with such a structure, the three tension rods 65, 67, 69 are inserted to the elongated slots extending in straight directions connected to the tension rod 63 whose position is restricted, whereby the positioning is implemented for the rotational directions of the stack component parts centering about the tension rod 63 and it is possible to respond to thermal expansions of the stack component parts.

Further, the tightening and rotating directions of the tension rods are set in the same way as those of the first embodiment such that the rotational directions of the tightening portions of the tension rods 63, 67, placed in positions diagonal to one another, are set to be opposite to one another and, also, the rotational directions of the tightening portions of the tension rods 65, 69, placed in positions diagonal to one another, are set to be opposite to one another. Of course, it may be sufficed that a plurality of tightening portions include at least one tightening portion that can be rotated in a direction opposite to that of the others.

As set forth above, since the structure of the presently filed embodiment is configured such that the directions, in which the fuel cell stack components are thermally expanded during the operation to generate electric power, are set to extend along the elongated slots 73, 75 in the areas where the temperatures increase while permitting the tension rods 67, 69 to be relatively movable along the elongated slots 73, 75 during the thermal expansions of the stack component parts, it becomes possible to alleviate stresses acting in diametric directions during thermal expansions, thereby effectively eliminating the occurrence of thermal distortion.

Furthermore, since the holes to which the tension rods 65, 67, 69 are inserted are formed in the elongated slots 77, 73, 75, a contact surface area between the associated component parts decreases, providing the ease of tightening work.

In addition, the tension rods 63, 67, 69, 65 are tightened in this order during assembling and the tightening portions in pair, placed in the positions opposing to one another on the diagonal lines, are tightened in a set in sequence, enabling the torsion of the fuel cell stack to be prevented in a further reliable fashion.

### Third Embodiment

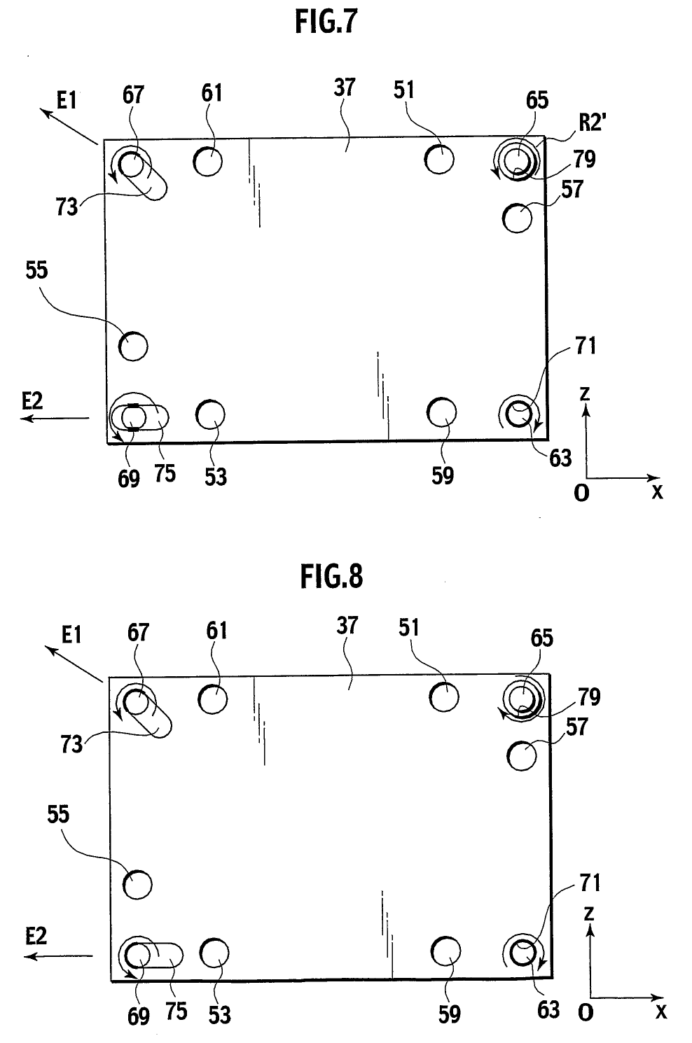

Now, a fuel cell stack and its related method of a third embodiment according to the present invention are described below in detail mainly with reference to FIG. 7.

FIG. 7 is a schematic view, corresponding to FIG. 4, which shows a structure of an end plate of the fuel cell stack of the presently filed embodiment.

The presently filed embodiment differs from the second embodiment mainly in respect of a shape of a hole to which the tension rod 65, placed in an upper area on the right side in FIG. 7, and the relationship between the tension rod 69, placed in the lower area on the left side, and the elongated slot 75. Hereunder, with attention focused on such a difference, the same component parts bear like reference numerals to suitably simplify or omit description.

In particular, the hole 79 through which the tension rod 65 is inserted is formed in a circular shape with a diameter larger than that of the tension rod 65 to cause the tension rod 65 not to be brought into contact with the hole 79 and the tension rod 69 is displaced to a center in a longitudinal direction of the elongated slot 75.

With such an arrangement, a tightening and rotating direction of the tension rod 65 is set to be counterclockwise direction R2′ opposite to that of the second embodiment, and all tightening and rotating directions of the tension rods 65, 67, 69 are set to be opposite to that of the tension rod 63 placed near the coolant water inlet 59.

Further, the tension rods 63, 65, 67, 69 are assembled in the same order as those of the second embodiment. In this case, by assembling the tension rod 65, located in a position closest to the tension rod 63, whose position is restricted, and with less momentum applied to the fuel cell stack during tightening work, in a final stage, the occurrence of distortion of the fuel cell stack can be further reliably prevented.

As set forth above, with the structure of the presently filed embodiment, it becomes possible to reduce contact surface areas between the tension rods 63, 65, 67, 69 and the component parts of the fuel cell stack, that is, holes 71, 73, 75, 79 in the stack direction, enabling further reduction in a total sum of momentums that would otherwise cause the fuel cell stack to be distorted during tightening thereof.

Furthermore, by setting the rotational directions of the tightening portions of the tension rods 67, 69 other than the tension rod 65, which is held in non-contact with the hole 79, to be opposite to that of the tension rod 63, a total contact surface area between the tension rods and the stack component parts can be reduced.

This is because of the fact that if the tightening portion of the tension rod 69 placed in the lower area on the left side in FIG. 7 is rotated in the same direction as that in which the tension rod 63 is rotated, a need arises for a contact surface area between the tension rod 67 in the upper area on the left side and the stack component parts to be greater than a contact status with only a semicircular peripheral portion (half circumference).

Moreover, by assembling the tension rod 65, placed in the position closest to the tension rod 63, whose position is restricted, and with less momentum applied to the fuel cell stack during tightening work, in a final stage, the distortion of the fuel cell stack can be further reliably prevented.

### Fourth Embodiment

Now, a fuel cell stack and its related method of a fourth embodiment according to the present invention are described below in detail mainly with reference to FIG. 8.

FIG. 8 is a schematic view, corresponding to FIG. 4, which shows a structure of an end plate of the fuel cell stack of the presently filed embodiment.

The presently filed embodiment differs from the second embodiment only in respect of a shape of a hole to which the tension rod 65 placed in the upper area on the right side in FIG. 8. Hereunder, with attention focused on such a difference, the same component parts bear like reference numerals to suitably simplify or omit description.

In particular, the hole 79, to which the tension rod 65 placed in the upper area on the right side is inserted is formed in the same circular shape as that of the third embodiment and also made greater than an outer diameter of the tension rod 65 to cause the tension rod 65 to be held in non-contact with the hole 79, and other structure and rotational directions and an assembling order of tightening portions of the tension rods is similar to those of the second embodiment.

That is, with such a structure, a contact surface area between the tension rod 63, placed in the vicinity of the coolant water inlet 59, and the fuel cell stack component parts is equalized with a total sum of the contact surface areas between the other tension rods 65, 67, 69 and the fuel cell stack component parts. The former contact surface area corresponds to an entire circumference in a circumferential direction of the tension rod 63 and the latter contact surface area corresponds to a total sum between the contact surface area associated with a semi-circumference (half circumference) in the circumferential direction of the tension rod 67 and the contact surface area associated with a semi-circumference (half circumference) in the circumferential direction of the tension rod 69.

This makes it possible to achieve further reduction in a total sum of momentums that would cause the fuel cell stack to be distorted.

Further, although the same is true in the second and third embodiments, the tension rods 63, 65, 67, 69 are assembled in an order such that the tension rod 63, placed near the coolant water inlet 59, is initially tightened and, subsequently, the remaining tension rods 65, 67, 69 are tightened in an order in which a distance from the tension rod 63 is long. That is, after the tension rod 63 is tightened, then, the tension rods 67, 69, 65 are assembled in such an order.

In such a case, by assembling the tension rod 65, placed in the position closest to the tension rod 63 whose position is restricted, with less momentum applied to the fuel cell stack during tightening work, in the last stage, it becomes possible to suppress the distortion of the fuel cell stack in a further reliable fashion.

With the structure of the presently filed embodiment as set forth above, since the contact surface area between the tension rod 63 and the fuel cell stack component parts is made equal to the total sum of the contact surfaces areas between the other tension rods 65, 67, 69 and the fuel cell stack component parts, the total sum of momentums that would cause the distortion to occur on the fuel cell stack during tightening work can be reduced and upon assembling the tension rod 65 in the final stage, the distortion of the fuel cell stack can be reliably prevented.

Incidentally, the fuel cell stacks of the various embodiments set forth above may be preferably installed on a fuel cell powered vehicle but also may have applications to other domestic uses, and electric power generator for industrial use.

Summarizing the above, according to the present invention, when permitting the plurality of tension rods and the nuts, screwed onto the threaded portions of the tension rods, to be rotated with respect to one another for tightening, the rotational directions of the plural tightening portions composed of the tension rods and the nuts are set to allow the tightening direction of at least one tightening portion to be opposite to those of the other tightening portions. This results in a capability for the momentum, which would act on the fuel cell stack to cause a so-called distortion, to be minimized for enabling the prevention of the distortion of the entire stack body, thereby enabling the surface pressure distribution appearing on the fuel cell stack to be equalized.

Further, among the plural tightening portions, the positioning of the fuel cell stack components is made by at least two tightening portions one of which plays a role as a first tightening portion that is located in the vicinity of the inlet of coolant water supplied to the stack body and held in close contact with the internal wall of the first through-hole formed in the stack component parts for insertion of the tension rod. In addition, among the tightening portions by which the positioning is made, the other tightening portion plays a role as a second tightening portion that is held in contact with a part of the second through-hole formed in the stack component parts for insertion of the tension rod for the purpose of carrying out the positioning of the tightening portions of the fuel cell stack component parts in the rotational direction during tightening work.

Furthermore, such a second through-hole has the linear portions, extending parallel to each other, as parts of the contact portions for the tension rod of the second tightening portion and the linear portions are made parallel to a linear direction between which the center of the first tightening portion and a center of the second tightening portion is interconnected to allow the direction in which the stack component parts are expanded and a direction of the elongated slot to match each other. That is, the presence of the tension rods given with appropriate tightening forces allows the tightening portions to be relatively movable along the associated elongated slots during thermal expansions of the fuel cell stack component parts, making it possible to alleviate stresses applied in diametric directions of the tightening portions during thermal expansion for thereby enabling to suppress the distortion of the fuel cell stack.

Moreover, by setting the rotational directions of the tightening portions, located in the positions opposing to one another with respect to the center of the unit cell, to be opposite to one another, the total sum of the momentums, acting on the fuel cell stack causing the distortion thereof, can be minimized.

Further, the tightening portions, placed in the positions opposite to one another, are tightened in pair in a sequence, enabling the reduction in the distortion of the fuel cell stack.

Furthermore, by providing the through-hole, with which the tension rod is held in non-contact, while the rotational direction of the second tightening portion held in contact with the part of the second through-hole is set to be opposite to that of the first tightening portion of the tension rod held in closed contact with the inner wall of the first through-hole, the total contact surface area between the respective tension rods and the fuel cell stack component parts is reduced, thereby enabling reduction in the momentum acting on the fuel cell stack causing the distortion thereof.

Moreover, the contact surface area between the tension rod of the first tightening portion and the first through-hole of the stack component parts is equalized with the contact surface area between the tension rod of the other tightening portion and the through-hole of the stack component parts, to which the tension rod is inserted, enabling reduction in the momentum acting on the fuel cell stack causing the distortion thereof.

Besides, among the tightening portions, since the first tightening portion is initially tightened and the other tightening portions are tightened in an order wherein a distance between the first tightening portion and the relevant tightening portion is long, the tightening portion, with less momentum acting on the fuel cell stack resulting from tightening of the tightening portion, can be tightened in a final stage, thereby suppressing the distortion of the fuel cell stack.

The entire content of a Patent Application No. TOKUGAN 2004-124061 with a filing date of Apr. 20, 2004 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

According to the present invention set forth above, since rotational directions of a plurality of tightening portions composed of tension rods and nuts are arranged such that the rotational direction of the other tightening portion is set to be opposite to that of at least one tightening portion, a momentum acting on a fuel cell stack causing distortion thereof can be reduced to preclude the distortion of entire stack, equalizing a surface pressure distribution on a fuel cell stack. Therefore, such a fuel cell stack is able to exhibit desired performance on an easy assembling process in a stable manner and applicable not only to fuel cell powered vehicles but also to various domestic and industrial equipment to be expected to applications in wide ranges.

1. A fuel cell stack comprising:
a plurality of fuel cells stacked in a stack direction to form a stack body, each of the plurality of fuel cells including an electrolyte membrane, an anode electrode placed on one side of the electrolyte membrane, a cathode electrode placed on the other side of the electrolyte membrane, and a pair of separators between which the anode electrode, the electrolyte membrane and the cathode electrode are sandwiched;
a pair of fixing members disposed on both sides of the stack body in the stack direction, the stack body and the pair of fixing members forming a stack structural part;
a plurality of rod members penetrating through the stack body and the pair of fixing members; and
a plurality of tightening members available to screw onto the plurality of rod members to form a plurality of tightening portions, respectively, whose tightening and rotating directions are set such that the tightening and rotating direction of the other tightening portion is set to be opposite to that of at least one tightening portion.

2. The fuel cell stack according to claim 1, wherein the plurality of tightening members includes nut members, respectively.

3. The fuel cell stack according to claim 1, wherein the stack structural part has a plurality of through-holes, for insertion of the plurality of rod members, respectively, which has shapes adapted to be held in contact with the plurality of rod members on entire circumferences thereof.

4. The fuel cell stack according to claim 1, wherein the at least two of the plurality of tightening portions achieve positioning of the stack structural part.

5. The fuel cell stack according to claim 4, wherein the plurality of tightening portions includes a first tightening portion inserted to a first through-hole, located in the stack structural part in the vicinity of an inlet of coolant water supplied to the stack body for insertion of one of the plurality of rod members, in close contact therewith for achieving the positioning, and a second tightening portion held in contact with a part of a second through-hole, formed in the stack structural part for insertion of another one of the plurality of rod members, to achieve the positioning in the tightening and rotating direction.

6. The fuel cell stack according to claim 5, wherein the second through-hole is formed in an elongated slot that has linear portions, parallel to one another, which serve as contact portions for the rod member associated with the second tightening portion.

7. The fuel cell stack according to claim 6, wherein the contact portions include a circular arc portion of the elongated slot.

8. The fuel cell stack according to claim 6, wherein the linear portions of the elongated slot are oriented in a linear direction on which the first and second tightening portions are placed.

9. The fuel cell stack according to claim 5, wherein the tightening and rotating direction of the second tightening portion is opposite in direction to that of the first tightening portion.

10. The fuel cell stack according to claim 5, wherein the a contact surface area of the rod member associated with the first tightening portion is equal to a total sum of contact surface areas of the rod members associated with the other tightening portions.

11. The fuel cell stack according to claim 5, wherein the first tightening portion is initially tightened and the other tightening portions are tightened in an order in which a distance from the first tightening portion is long.

12. The fuel cell stack according to claim 5, further comprising:
a third tightening portion with a hole larger in diameter than a rod member that is associated.

13. The fuel cell stack according to claim 1, wherein the two of the plurality of tightening portions is disposed in positions symmetric with respect to a center point of a surface, of at least one of the pair of fixing members, on a plane perpendicular to the stack direction.

14. The fuel cell stack according to claim 12, wherein the tightening and rotating directions of the two of the plurality of tightening portions are set to be opposite to one another.

15. A method of tightening a fuel cell stack which has a plurality of unit cells stacked in a stack direction to form a stack body, a pair of fixing members disposed on both sides of the stack body in the stack direction thereof, a plurality of rod members penetrating through the stack body and the pair of fixing members, and a plurality of tightening members screwed onto the plurality of rod members to form a plurality of tightening portions, respectively, the method comprising:
penetrating a plurality of rod members through the stack member and the pair of fixing members; and
permitting the plurality of rod members and a plurality of tightening members to screw on each other such that a tightening and rotating direction of the other one of the plurality of tightening portions is set to be opposite to that of at least one of the plurality of tightening portions.
